(19) United States
(12) Patent Application Publication
(10) Pub. No.: US 2014/0164170 A1
(43) Pub. Date: Jun. 12, 2014

(54) CONFIGURABLE MULTI-OBJECTIVE RECOMMENDATIONS

(71) Applicants: Wen-Syan Li, Fremont, CA (US); Bin Dong, Shanghai (CN); Teller Lin, Shanghai (CN); Tianyu Luwang, Shanghai (CN); Yongyuan Shen, Shanghai (CN); Xingtian Shi, Shanghai (CN); Zheng Long Wei, Shanghai (CN); Zheren Zhu, Shanghai (CN)

(72) Inventors: Wen-Syan Li, Fremont, CA (US); Bin Dong, Shanghai (CN); Teller Lin, Shanghai (CN); Tianyu Luwang, Shanghai (CN); Yongyuan Shen, Shanghai (CN); Xingtian Shi, Shanghai (CN); Zheng Long Wei, Shanghai (CN); Zheren Zhu, Shanghai (CN)

(21) Appl. No.: 13/720,031

(22) Filed: Dec. 19, 2012

(30) Foreign Application Priority Data
Dec. 12, 2012 (CN) 201210536851.9

(51) Int. Cl. G06Q 30/06

(52) U.S. Cl. CPC G06Q 30/0631
USPC 705/26.7

(57) ABSTRACT

The method includes determining at least one business objective on which to base a recommendation list for a first item, associating a configurable target with the business objective, the configurable target being based on a goal for a second item, determining at least one business constraint relating the first item with the second item, the at least one business constraint being based on the business objective and the associated configurable target and generating the recommendation list for the first item based on a list of candidate items and the business constraint.

### CROSS-REFERENCE TO RELATED APPLICATION

This application claims priority under 35 U.S.C. §119 to Chinese Patent Application 201210536851.9, filed Dec. 12, 2012, titled “CONFIGURABLE MULTI-OBJECTIVE RECOMMENDATIONS”, which is incorporated herein by reference in its entirety.

### BACKGROUND

1. Field

This description relates to a method, system and computer readable medium for generating constraint based recommendation lists.

2. Related Art

There are many types of recommender systems, including content-based filtering and collaborative filtering. Typically collaborative filtering has two major approaches. The first is a user-based approach and the second is an item-based approach. Typically a recommender system computes a ranking list of items based on their interest to a user. The system suggests top N items of the list to the user, where N is a predefined size of the recommendation list.

However, the typical approach disregards the relationship between the items included in the recommendation list. For a customer may have purchased a new mobile phone, a recommendation list with different related accessories for that mobile phone may have a higher combined interest to the user than a recommendation list with a list of mobile phones even though each mobile phone in the list is of high interest to the user. A typical recommender system focuses on users' interest without taking business purposes into consideration.

### SUMMARY

According to one or more example embodiments, a recommender system generates lists taking some business constraints into consideration. Accordingly, a recommendation list for an item which may satisfy one or more constraints and has a desired combined evaluation value among all lists meeting the constraints. This recommendation list for an item may be displayed (e.g., recommended) to a user (e.g., shopper on an e-commerce website) if the user browses to the item.

One embodiment includes a method for generating a recommendation list. The method includes determining at least one business objective on which to base a recommendation list for a first item, associating a configurable target with the business objective, the configurable target being based on a goal for a second item, determining at least one business constraint relating the first item with the second item, the at least one business constraint being based on the business objective and the associated configurable target and generating the recommendation list for the first item based on a list of candidate items and the business constraint.

Another embodiment includes a system for generating a recommendation list. The system includes a first module configured to determine at least one business objective on which to base a recommendation list for a first item, and configured to generate the recommendation list for the first item based on a list of candidate items and at least one business constraint, and at least one second module configured to associate a configurable target with the business objective, the configurable target being based on a goal for a second item and configured to determine the at least one business constraint relating the first item with the second item, the at least one business constraint being based on the business objective and the associated configurable target.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of a system according to one or more example embodiments.

FIG. 2 illustrates a method according to one or more example embodiments.

FIG. 3A illustrates a user interface according to one or more example embodiments.

FIG. 3B illustrates another user interface according to one or more example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments are may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

### VARIABLE DEFINITIONS

The following is a list of variable definitions used throughout this specification. Each of the variables may be used in one or more of the equations described below.

I: Item list which is the list of all items (e.g., all of the products on an e-commerce website).

|I|: The total number of items.

TDᵢⱼ: The transfer rate matrix without recommendation (TD) which is the probability of purchasing item j after viewing item i if item j is not in the recommendation list.

TRᵢⱼ: The transfer rate matrix with recommendation (TR) which is the probability of purchasing item j after viewing item i if item j is in the recommendation list.

ATDᵢ: The average transfer rate list without recommendation (ATD) which is the probability of purchasing another item after viewing item i if the purchased item is not in the recommendation list.

ATRᵢ: The average transfer rate list with recommendation (ATR) which is the probability of purchasing another item after viewing item i if the purchased item is in the recommendation list.

Sᵢⱼ: The item similarity matrix over users' interest (S) which is the similarity between item i and item j.

N(i): The set of users who have purchased item i (or put into wish list or liked etc.).

|N(i)|: The number of users who have purchased item i.

|N(i)N∩(j)|: The number of users who purchased both item i and item j.

Vᵢ: The expected number of views on an item i in a time interval (e.g., a week or a month).

PIDⱼ: The independent price image of an item j. The value of PIDⱼ is less than one (1) if the user is under the impression that the price of the item j is lower than expected without considering other items (the more negative, the stronger the impression). The value of PIDⱼ is greater than one (1) if the user is under the impression that the price of the item j is higher than expected without considering other items (the more positive, the stronger the impression). The value of PIDⱼ is equal to zero (0) if the user is under the impression that the price of the item j is as expected.

PIRᵢⱼ: The price image of an item j on the recommendation list of item i. For example, a mobile phone case priced at 100 dollars could have a independent price image much higher than 1. However, if the mobile phone case appears on the recommendation list of a high end mobile phone, then the mobile phone case's price image could be lower than 1.

RUⱼ: The unit revenue of an item j.

PUⱼ: The unit profit margin of an item j.

Fᵢⱼ: The satisfaction degree on the recommendation of item j on viewing item i.

Δᵢⱼ: The expected increase in sales of item j if the item is in the recommendation list of item i.

Rᵢⱼ: The expected increase in revenue of item j if the item is in the recommendation list of item i.

Pᵢⱼ: The expected increase in profit of item j if the item is in the recommendation list of item i.

Eᵢⱼ: The evaluation function of item j if the item is in the recommendation list of item i.

Cᵢ: The pool of recommendation items of item i.

d: The size of the recommendation list of item i.

M(i): The recommendation list for item i.

### Equations

$$\begin{matrix}{S}_{ij} = \frac{\vert N ( i ) ⋂ N ( j ) \vert}{\sqrt{\vert N ( i ) \vert \vert N ( j ) \vert}} & ( 1 ) \\ {TD}_{ij} = \frac{{S}_{ij}}{{\sum }_{j = 1}^{\vert I \vert} {S}_{ij}} {ATD}_{i} & ( 2 ) \\ {TR}_{ij} = \frac{{S}_{ij}}{{\sum }_{j = 1}^{\vert I \vert} {S}_{ij}} {ATR}_{i} & ( 3 ) \\ {Δ}_{ij} = {V}_{i} ( {TR}_{ij} - {TD}_{ij} ) & ( 4 ) \\ {R}_{ij} = {Δ}_{ij} {RU}_{j} & ( 5 ) \\ {P}_{ij} = {Δ}_{ij} {PU}_{j} & ( 6 ) \\ {E}_{ij} = {w}_{1} {Δ}_{ij} + {w}_{2} {PIR}_{ij} + {w}_{3} {R}_{ij} + {w}_{4} {P}_{ij} + {w}_{5} {F}_{ij} & ( 7 ) \\ f ( b ) = {b}_{1} {E}_{i , {C ( i )}_{1}} + {b}_{2} {E}_{i , {C ( i )}_{2}} + … + {b}_{\vert C ( i ) \vert} {E}_{i , {C ( i )}_{\vert C ( i ) \vert}} & ( 8 )\end{matrix}$$

### Constraints

Σ_{jεM(i)}Δᵢⱼ≧threshold of increase in combined sale quantity (9)

Σ_{jεM(i)}PIRᵢⱼ≦threshold of combined price image (10)

Σ_{jεM(i)}≧Rᵢⱼ≧threshold of increase in combined revenue (11)

Σ_{jεM(i)}Pᵢⱼ≧threshold of increase in combined profit (12)

Σ_{jεM(i)}Fᵢⱼ≧threshold of increase in combined sale quantity (13)

Σ_{jεC(i)}bⱼ=d (14)

### DESCRIPTION OF THE FIGURES

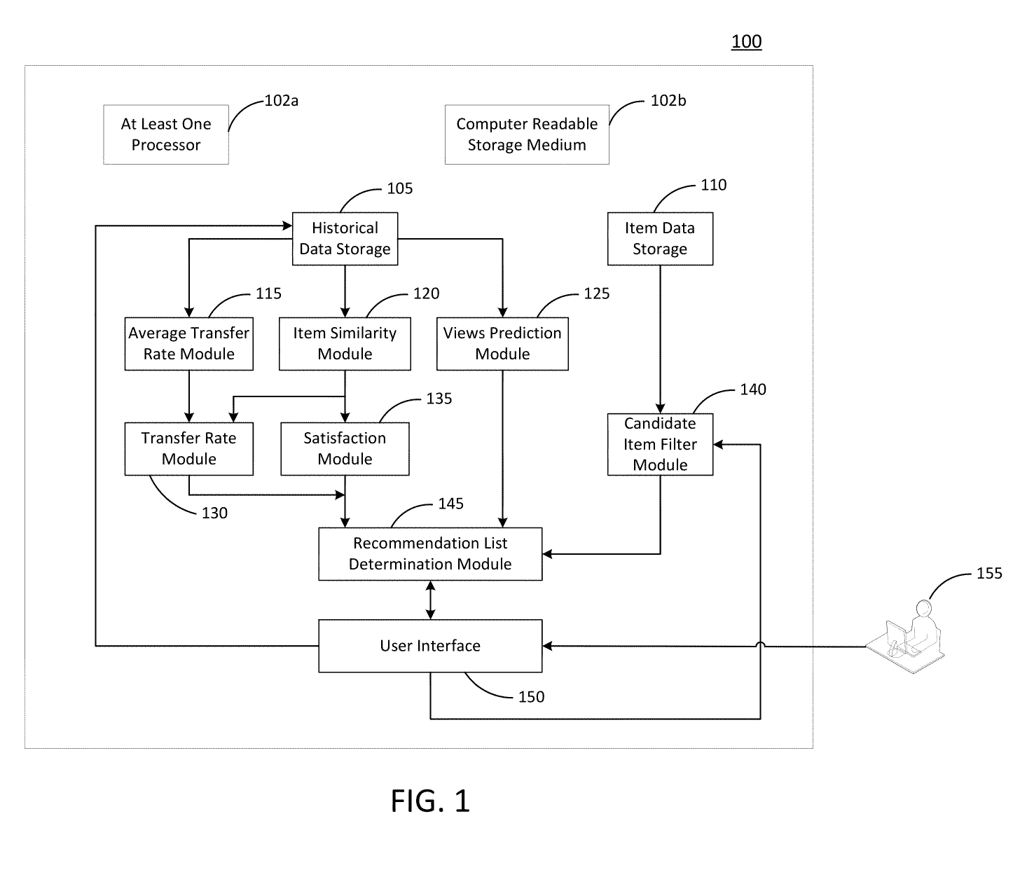

FIG. 1 illustrates a block diagram of a system according to one or more example embodiments. As shown in FIG. 1, the system 100 includes historical data storage 105, item data storage 110, an average transfer rate module 115, an item similarity module 120, a view prediction module 125, a transfer rate module 130, a satisfaction module 135, a candidate item filter module 140, a recommendation list determination module 145, and a user interface 150.

In the example of FIG. 1, the system 100 may be at least one computing device and should be understood to represent virtually any computing device configured to perform the methods described herein. As such, the system 100 may be understood to include various standard components which may be utilized to implement the techniques described herein, or different or future versions thereof. By way of example, the system 100 is illustrated as including at least one processor 102A, as well as a computer readable storage medium 102B.

Thus, as may be appreciated, the at least one processor 102A may be utilized to execute instructions stored on the computer readable storage medium 102B, so as to thereby implement the various features and functions described herein, or additional or alternative features and functions. Of course, the at least one processor 102A and the computer readable storage medium 102B may be utilized for various other purposes. In particular, it may be appreciated the computer readable storage medium 102B may be understood to represent an example of various types of memory and related hardware and software which might be used to implement any one of the modules described herein.

The historical data storage 105 may be configured to store historical data associated with, for example, item price, item revenue, item profit, item customer satisfaction, item price image, recommendation lists associated with the item, and the like. The historical data storage 105 may be configured as a database, a table in a database, a XML dataset or some other searchable and filterable data-store (e.g., memory). The historical data storage 105 may be configured to store data that is continually updated and added over time.

The item data storage 110 may be configured to store current data associated with, for example, item price, item revenue, item profit, item customer satisfaction, item price image, a current recommendation list associated with an item, and the like. The item data storage 110 may be configured as a database, a table in a database, a XML dataset or some other searchable and filterable data-store (e.g., memory). The item data storage 110 may be configured to store data that is updated and added over time.

The average transfer rate module 115 may be configured to determine the average probability that an item will be purchased if the item is in a recommendation list for another item. For example, the average transfer rate module 115 may read the average transfer rate list without recommendation (ATD), and the average transfer rate list with recommendation (ATR) for item i from the historical data storage 105. For example, the average transfer rate module 115 may read ATD and ATR for all items and one of search the lists or filter the lists based on item i in order to determine ATDᵢ and ATRᵢ.

The item similarity module 120 may be configured to determine the similarity between two items Sᵢⱼ. For example, the similarity between item i and item j may be determined using equation (3). For example, the set of users who have purchased item an item N may be read from the historical data storage 105. The item similarity module 120 may one of search N or filter N in order to determine N(i) and N(j). The item similarity module 120 may determine the similarity between two items Sᵢⱼ based on N(i) and N(j) utilizing equation (3).

The view prediction module 125 may be configured to determine (e.g., predict) an expected number of views of an item. For example, the view prediction module 125 may read the number of views of all items over a time interval (e.g., a week or a month) from the historical data storage 105. The view prediction module 125 may one of search or filter number of views of the item over a period of time in order to determine the number of views of the item i over the period of time and set the result as the expected number of views Vᵢ of the item i.

The transfer rate module 130 may be configured to determine the probability that an item will be purchased if the item is in a recommendation list for another item. For example, the probability of purchasing item j after viewing item i if item j is in the recommendation list TDᵢⱼ may be determined using equation (2). For example, the probability of purchasing item j after viewing item i if item j is not in the recommendation list TRᵢⱼ may be determined using equation (3). The item similarity matrix over users' interest Sᵢⱼ, the average transfer rate list without recommendation (ATD), and the average transfer rate list with recommendation (ATR) may be read from the historical data storage 105 by the item similarity module 120 and the average transfer rate module 115, respectively as described above.

The satisfaction module 135 may be configured to determine the satisfaction of an item in a recommendation list for another item. For example, a satisfaction degree of item j if viewing item i Fᵢⱼ may be based on the determined item similarity matrix Sᵢⱼ and the determined set of users who have purchased item i N(i). For example, the item similarity matrix Sᵢⱼ may be filtered or searched with N(i) as a key.

The candidate item filter module 140 may be configured to determine a candidate pool of recommendation items to be displayed in the recommendation list. For example, item data stored in the item data storage 110 may be filtered based on some criteria. For example, if viewing item i is some form of electronic device for sale on a large e-commerce website, displaying non-electronic device related items (e.g., furniture, clothing or linen) may not be desired. Therefore, the candidate item filter module 140 may filter unrelated items in order to determine the candidate pool of recommendation items Cᵢ.

The recommendation list determination module 145 may be configured to determine a recommendation list based on a selected item and one or more business objectives (e.g., as determined by the aforementioned modules). For example, determining the recommendation list for an item i M(i) may include determining a plurality of recommendation lists for the item i and evaluating each of the plurality of recommendation lists for the item i in order to select the best list to meet the business objectives. For example, the determination module 145 may execute the evaluation function Eᵢⱼ (eqn. (7)) for each of the plurality of recommendation lists. The best recommendation list may have the highest evaluation value among all lists conforming to one or more of the constraints (e.g., constraints 9-12). The expected increase in sales of item j if item j is a member of the recommendation list of item i Δᵢⱼ may be in-turn be determined using equation (4).

Once the expected increase in sales Δᵢⱼ is determined, other business objectives for the recommendation list may also be determined. For example, the expected increase in revenue Rᵢⱼ and the expected increase in profit Pᵢⱼ may be calculated utilizing equations (5) and (6) respectively.

Further, according to one or more example embodiments, the effect of including item j in the recommendation list M(i) of item i may be evaluated as a weighted sum of a plurality of related factors (e.g., business objectives), including, for example, the increase in sales Δᵢⱼ, the new price image PIRᵢⱼ, the increase in revenue Rᵢⱼ, the increase in profit Pᵢⱼ, and the satisfaction degree Fᵢⱼ. In one or more example embodiment, the evaluation function for including item j in the recommendation list of item i may be determined using equation (7). Where the weights w may be user determined inputs. Further, the evaluation function for the whole recommendation list is the sum of the evaluation values for all items in the recommendation list. For example, the determination module 145 may execute the evaluation function Eᵢⱼ (eqn. (7)) for the related factors (e.g., business objectives) conforming to one or more of the constraints (e.g., constraints 9-12).

Further, according to one or more example embodiments, determining the best recommendation list may include solving an integer linear programming problem. For example, assuming a pool of candidate recommendation items of item i is C(i) (with items of C(i)₁, C(i)₂, . . . , C(i)_{|C(i)|}) and the size of recommendation list is d. The integer unknowns are b₁, b₁, . . . , b_{|C(i)|}(bⱼε{0,1}). The integer linear programming may maximize equation (8) subject to constraint (13).

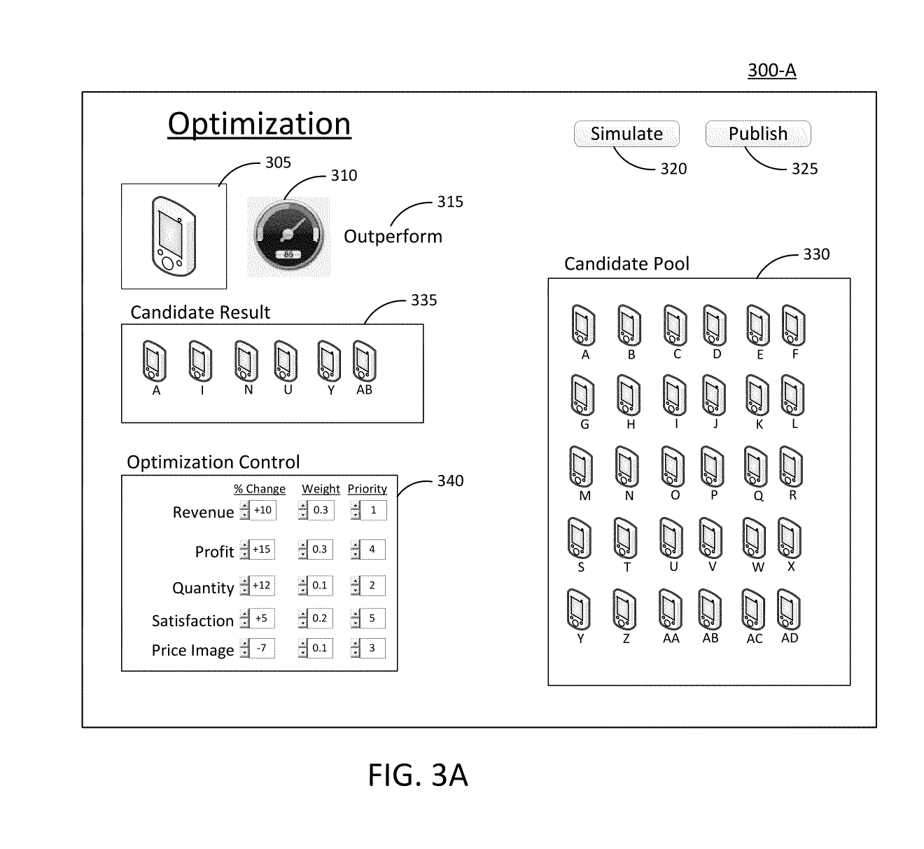

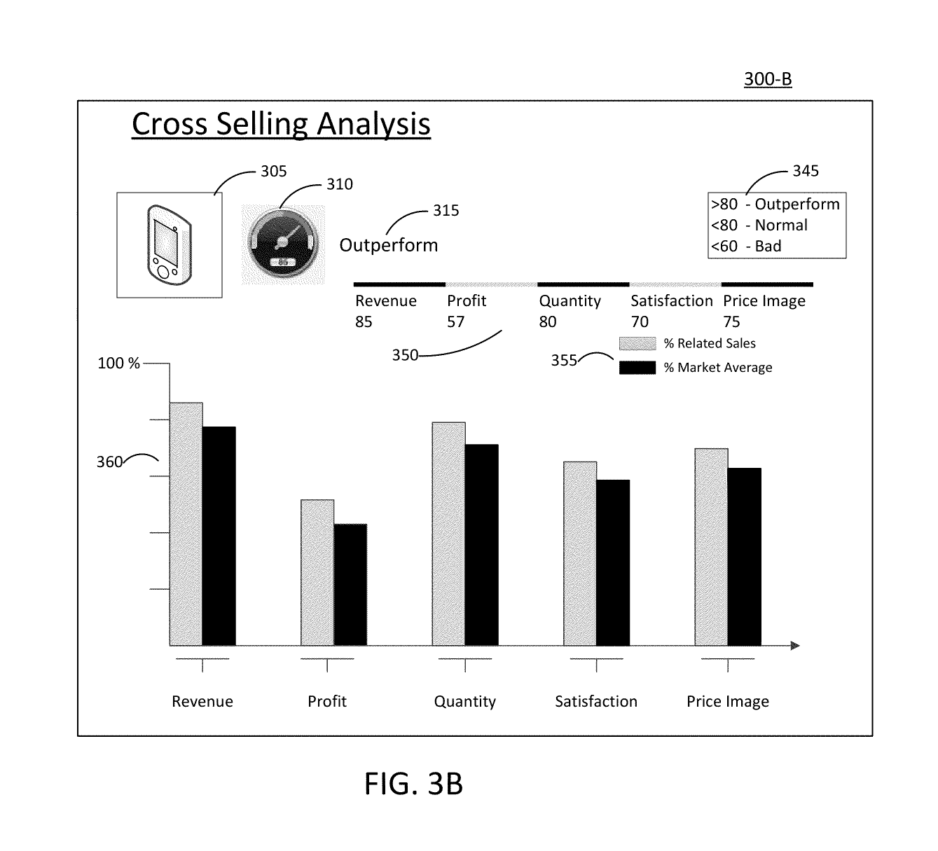

The user interface 150 may be configured to allow a user 155 to input configurable parameters (e.g., weight w) and display resultant recommendation lists together with some evaluations of the recommendation lists. In example embodiments, the user 155 may be an administrator, a sales coordinator or some other individual or group of individuals associated with the administration and experience associated with configuring and delivering an e-commerce website. An example user interface is described below in more detail with regard to FIGS. 3A and 3B.

Each of the modules described above may be executed as software code stored in a memory associated with system 100 and executed by a processor associated with system 100. For example, the processor may be associated with one or more of the business objective modules (e.g., the view prediction module 125 or the transfer rate module 130) or the recommendation list determination module 145. However, alternative embodiments are contemplated. For example, the modules may be embodied as an application-specific integrated circuit, or ASIC. For example, the ASIC may be configured as one or more of the business objective modules (e.g., the view prediction module 125 or the transfer rate module 130) or the recommendation list determination module 145. However, alternative embodiments are contemplated.

According to example embodiments, the described business objective modules may not be an all inclusive list. For example, the average transfer rate module 115, the item similarity module 120, the view prediction module 125, the transfer rate module 130, and the satisfaction module 135 are examples of business objective modules. However, other business objectives may be apparent to those skilled in the art. For example, other business objectives may include profit margin, inventory objectives, preferred supplier objectives, item delivery objectives, quality objectives and the like. Corresponding equations and constraints may be developed by those skilled in the art. For example, a profit margin may be maximized or an inventory level may be reduced.

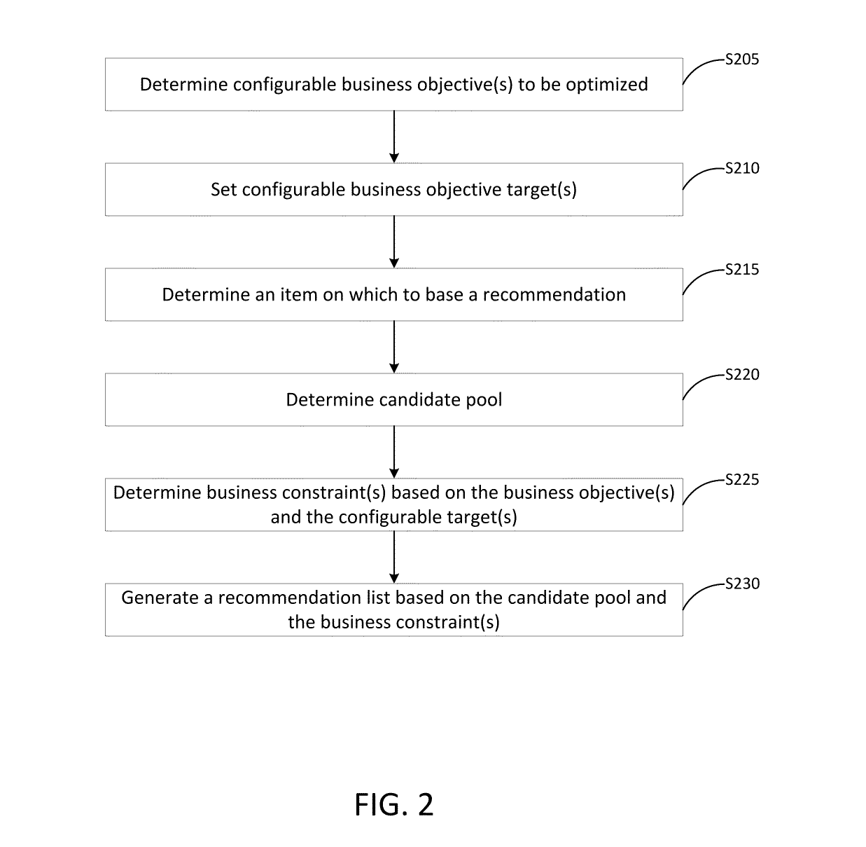

FIG. 2 illustrates a method according to one or more example embodiments. As one skilled in the art will appreciate, the method steps described with regard to FIG. 2 may be executed as software code stored in a memory associated with system 100 and executed by a processor (e.g., the at least one processor 102A) associated with system 100. For example, the processor may be associated with one or more of the business objective modules (e.g., the view prediction module 125 or the transfer rate module 130) or the recommendation list determination module 145. However, alternative embodiments are contemplated. For example, the method steps may be performed by an application-specific integrated circuit, or ASIC. For example, the ASIC may be configured as one or more of the business objective modules (e.g., the view prediction module 125 or the transfer rate module 130) or the recommendation list determination module 145. However, alternative embodiments are contemplated. Although the steps described below are described as being executed by a processor, the steps are not necessarily executed by a same processor. In other words, at least one processor may execute the steps described below with regard to FIG. 2.

In step S205 the processor determines configurable business objectives to be optimized. For example, the business objectives may include revenue, profit, quantity, satisfaction, price image, and the like. The processor may determine (e.g., select) the configurable business objectives based on user input via, for example, user interface 150. Data associated with the configurable business objectives may be determined by one or more of the modules discussed above with regard to FIG. 1.

In step S210 the processor sets one or more configurable business objective targets. For example, the processor may set the one or more business objective targets based on a market average for each of the determined configurable business objectives. For example, the processor may set the one or more business objective targets to be some percentage higher or lower than a market average for a product line (e.g., cell phones). Alternatively (or in addition to), the processor may set the one or more business objective targets based on a historical average for each of the determined configurable business objectives. For example, the processor may set the one or more business objective targets to be some percentage higher or lower than a historical average for a selected item and/or a similar product. The historical average may be stored in the historical data storage 105. The historical average may be a recently executed simulation or may be based on a recently executed simulation.

In step S215 the processor determines an item on which to base a recommendation. For example, an e-commerce website may offer many (e.g., thousands, tens of thousands, millions, and etc.) of products for sale. An administrator (e.g., user 155) of the e-commerce website may utilize a user interface (e.g., user interface 150) to select a product to generate a recommendation list for from the offered products for sale.

In step S220 the processor determines a candidate pool. For example, item data stored in the item data storage 110 may be filtered based on some criteria. For example, if viewing item i is some form of electronic device for sale on a large e-commerce website, displaying non-electronic device related items (e.g., furniture, clothing or linen) may not be desired. For example, the processor may be associated with the candidate item filter module 140 which may filter unrelated items in order to determine the candidate pool of recommendation items Cᵢ.

In step S225 the processor determines a business constraint (or constraints) based on the sales objectives. For example, for each of the business objectives there may be an associated constraint. The constraints may be, for example, constraints (9)-(14) described in more detail above.

In step S230 the processor determines a recommendation list based on the candidate pool and the business constraint. For example, the processor may be associated with the recommendation list determination module 145. For example, as described above, determining the recommendation list for an item i M(i) may include determining a plurality of recommendation lists (or intermediate lists) for the item i and evaluating each of the plurality of recommendation lists (or intermediate lists) for the item i in order to select the best list to meet the business objectives. For example, the determination module 145 may execute the evaluation function Eᵢⱼ (eqn. (7)) for each of the plurality of recommendation lists. The best recommendation list may have the highest evaluation value among all lists conforming to one or more of the constraints (e.g., constraints 9-12). The expected increase in sales of item j if item j is a member of the recommendation list of item i Δᵢⱼ may be in-turn be determined using equation (4).

Once the expected increase in sales Δᵢⱼ is determined, other business objectives for the recommendation list may also be determined. For example, the expected increase in revenue Rᵢⱼ and the expected increase in profit Pᵢⱼ may be calculated utilizing equations (5) and (6) respectively.

Further, according to one or more example embodiments, the effect of including item j in the recommendation list M(i) of item i may be evaluated as a weighted sum of a plurality of related factors (e.g., business objectives), including, for example, the increase in sales Δᵢⱼ, the new price image PIRᵢⱼ, the increase in revenue Rᵢⱼ, the increase in profit Pᵢⱼ, and the satisfaction degree Fᵢⱼ. In one or more example embodiment, the evaluation function for including item j in the recommendation list of item i may be determined using equation (7), where the weights w may be user determined inputs. Further, the evaluation function Eᵢⱼ for the whole recommendation list is the sum of the evaluation values for all items in the recommendation list. For example, the determination module 145 may execute the evaluation function Eᵢⱼ (eqn. (7)) for the related factors (e.g., business objectives) conforming to one or more of the constraints (e.g., constraints 9-12).

Further, according to one or more example embodiments, determining the best recommendation list may include solving an integer linear programming problem. For example, assuming a pool of candidate recommendation items of item i is C(i) (with items of C(i)₁, C(i)₂, . . . , C(i)_{|C(i)|}) and the size of recommendation list is d. The integer unknowns are b₁, b₁, . . . , b_{|C(i)|}(bⱼε{0,1}). The integer linear programming may maximize equation (8) subject to constraint (13).

Further, according to one or more example embodiment, each business objective may have an associated priority. The priority may be used to configure the simulation (e.g., determination of the recommendation list) should the result of the simulation return an empty recommendation list (e.g., no items are shown). An empty recommendation list may be the result of not meeting the constraints for one or more of the business objectives. Adjusting the priority may be used to configure the determination of using equation (7) without a constraint associated with the lowest priority business objective. The determination of using equation (7) may be repeated with dropped constraints (e.g., lowest priority first) until an acceptable is determined.

FIG. 3A illustrates a user interface according to one or more example embodiments. The user interface 300-A may be an element of user interface 150. As shown in FIG. 3A, the user interface 300-A includes a selected item 305, a result indicator 310, a result status 315, a simulate button 320, a publish button 325, a candidate pool display 330, a candidate result display 335, and an optimization control 340.

The selected item 305 may be configured to select and display an item for which a recommendation list is to be generated. For example, a user (e.g., user 155) may use a dropdown list to select the item. Alternatively, the item may have been selected on another display (not shown). Alternatively, the user may enter an item number. One skilled in the art will recognize any number of mechanisms by which an item may be selected and displayed on a user interface.

The simulate button 320 may be configured to start a simulation resulting in the generation of a recommendation list. For example, pushing the simulate button may begin the execution of the steps described above with regard to FIG. 2.

The result indicator 310 may be configured to provide a visual indication of the results of the simulation. For example, the result indicator 310 may show the results on a scale (e.g., from 1-100) in order for the user to determine how acceptable (or inacceptable) the resultant recommendation list is. For example, the result indicator 310 may show Eᵢⱼ as determined using equation (7).

The result status 315 may be configured to provide a textual indication of the results of the simulation. For example, the result status 315 may be based on Eᵢⱼ as determined using equation (7). For example, a value of Eᵢⱼ may be compared to ranges and the result status may show a representative result of this comparison (e.g., poor, bad, good, acceptable, normal, outperform, and the like).

The publish button 325 may be configured to save the result of the simulation as the recommendation list to be displayed if the item is selected on an e-commerce website. For example, the recommendation list may be stored in the item data storage 110 in association with the item. For example, if a shopper on the e-commerce website selects the item, the recommendation list may be shown on the e-commerce website together with the selected item.

The candidate pool display 330 may be configured to display a candidate pool on which the recommendation list is based. For example, the candidate pool display 330 may display the list of items determined with regard to step S220 described above.

The candidate result display 335 may display the items in the recommendation list. For example, the candidate result display 335 may display the list of items determined with regard to step S230 described above.

The optimization control 340 may provide a mechanism by which the user may configure and/or select business objectives. For example, the user may select business objectives by right clicking on the optimization control 340 which may show a pop-up window (not shown) with a list of business objectives and check boxes. The user then selects the business objectives (e.g., revenue) to be configured.

The user may configure characteristics of the business objectives (e.g., % change, weight and priority). Although only three characteristics are shown, three is not a maximum or minimum and the characteristics are not limited to those shown. The user may change any of the characteristics and execute the simulation (e.g., press the simulate button 320) to execute a simulation based on the changes.

For example, each business objective may have a priority. The priority may be used to configure the simulation (e.g., determination of the recommendation list) should the result of the simulation return an empty recommendation list (e.g., no items are shown). An empty recommendation list may be the result of not meeting the constraints for one or more of the business objectives. Adjusting the priority may be used to configure the determination of Eᵢⱼ using equation (7) without a constraint associated with the lowest priority business objective. The determination of Eᵢⱼ using equation (7) may be repeated with dropped constraints (e.g., lowest priority first) until an acceptable Eᵢⱼ is determined.

For example, each business objective may have a weight. The weight may be an input (e.g., w) for the determination of Eᵢⱼ using equation (7).

FIG. 3B illustrates another user interface according to one or more example embodiments. The user interface 300-B may be an element of user interface 150. As shown in FIG. 3B, the user interface 300-B includes the selected item 305, the result indicator 310, the result status 315, a status legend 345, a results summary 350, a graph legend 355, and an analysis graph 360.

The selected item 305, the result indicator 310, and the result status 315 are described above with regard to FIG. 3A. The status legend 345 provides a legend for the result status 315.

The results summary 350 may show a result of any determination of a characteristic associated with the business objectives. For example revenue may be the result of a determination of revenue using equation (5).

The graph legend 355 provides a legend for the analysis graph 360. The analysis graph 360 may graphically show a comparison of the simulation for the configured characteristics of the business objectives. For example analysis graph may illustrate comparison to a market average for each of the determined configurable business objectives. For example, the one or more business objectives may be illustrated as some percentage higher or lower than a market average for a product line (e.g., cell phones).

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method for generating a recommendation list, the method comprising:
determining at least one business objective on which to base a recommendation list for a first item;
associating a configurable target with the business objective, the configurable target being based on a goal for a second item;
determining at least one business constraint relating the first item with the second item, the at least one business constraint being based on the business objective and the associated configurable target; and
generating the recommendation list for the first item based on a list of candidate items and the business constraint.

2. The method of claim 1, further comprising saving the recommendation list in a memory in association with the first item, the recommendation list being for display on an e-commerce website should the first item be selected for display on the e-commerce website.

3. The method of claim 1, further comprising:
generating an intermediate list including at least one second item from the list of candidate items, wherein
generating the recommendation list includes determining the result of an evaluation function for the intermediate list, the evaluation function being based on the at least one business constraint.

4. The method of claim 1, further comprising:
generating an intermediate list including at least one second item from the list of candidate items, wherein
the at least one business constraint includes at least two business constraints,
generating the recommendation list includes determining the result of an evaluation function for the intermediate list, the evaluation function being based on a weighted sum of the at least two business constraints.

5. The method of claim 1, further comprising:
generating an intermediate list including at least one second item from the list of candidate items, wherein
the business objective is a combined profit,
the target is an increased profit as compared to at least one other item in the list of candidate items, and
generating the recommendation list includes selecting the intermediate list as the recommendation list if a combined profit of the at least one second item is greater than a combined profit of the at least one other item.

6. The method of claim 1, further comprising:
generating an intermediate list including at least one second item from the list of candidate items, wherein
the business objective is a combined sales quantity,
the target is an increased sales quantity as compared to at least one other item in the list of candidate items, and
generating the recommendation list includes selecting the intermediate list as the recommendation list if a combined increase in sales quantity of the at least one second item is greater than a combined increase in sales quantity of the at least one other item.

7. The method of claim 1, further comprising:
generating an intermediate list including at least one second item from the list of candidate items, wherein
the business objective is a price image,
the target is an combined price image as compared to at least one other item in the list of candidate items, and
generating the recommendation list includes selecting the intermediate list as the recommendation list if a combined price image of the at least one second item is less than a combined price image of the at least one other item.

8. The method of claim 1, further comprising:
generating an intermediate list including at least one second item from the list of candidate items, wherein
the business objective is a combined revenue,
the target is an increased revenue as compared to at least one other item in the list of candidate items, and
generating the recommendation list includes selecting the intermediate list as the recommendation list if a combined revenue of the at least one second item is greater than a combined revenue of the at least one other item.

9. The method of claim 1, further comprising:
generating an intermediate list including at least one second item from the list of candidate items, wherein
the business objective is a combined satisfaction degree,
the target is a combined satisfaction degree as compared to at least one other item in the list of candidate items, and
generating the recommendation list includes selecting the intermediate list as the recommendation list if a combined satisfaction degree of the at least one second item is greater than a combined satisfaction degree of the at least one other item.

10. The method of claim 1, further comprising:
generating an intermediate list including at least one second item from the list of candidate items, wherein
the business objective is a profit margin,
the target is a maximum profit margin as compared to a market based average, the market based average being based on the first item, and
generating the recommendation list includes selecting the intermediate list as the recommendation list if a profit margin of the second item achieves the profit margin goal.

11. The method of claim 1, further comprising:
filtering a list of items for sale based on the first item, wherein generating the list of candidate items is based on the filtered list.

12. The method of claim 1, wherein the at least one business objective and the target for the business objective are selected using a user interface.

13. A system for generating a recommendation list, the system comprising:
a first module configured to determine at least one business objective on which to base a recommendation list for a first item, and configured to generate the recommendation list for the first item based on a list of candidate items and at least one business constraint; and
at least one second module configured to associate a configurable target with the business objective, the configurable target being based on a goal for a second item and configured to determine the at least one business constraint relating the first item with the second item, the at least one business constraint being based on the business objective and the associated configurable target.

14. The system of claim 13, further comprising:
a memory configured to store the recommendation list in association with the first item, the recommendation list being for display on an e-commerce website should the first item be selected for display on the e-commerce website.

15. The system of claim 13, wherein
the first module is configured to generate an intermediate list including at least one second item from the list of candidate items,
the at least one business constraint includes at least two business constraints, and
generating the recommendation list includes determining the result of an evaluation function for the intermediate list, the evaluation function being based on a weighted sum of the at least two business constraints.

16. The system of claim 13, wherein
the first module is configured to generate an intermediate list including at least one second item from the list of candidate items,
the business objective is a combined profit,
the target is an increased profit as compared to at least one other item in the list of candidate items, and
generating the recommendation list includes selecting the intermediate list as the recommendation list if a combined profit of the at least one second item is greater than a combined profit of the at least one other item.

17. The system of claim 13, wherein
the first module is configured to generate an intermediate list including at least one second item from the list of candidate items,
the business objective is a combined sales quantity,
the target is an increased sales quantity as compared to at least one other item in the list of candidate items, and
generating the recommendation list includes selecting the intermediate list as the recommendation list if a combined increase in sales quantity of the at least one second item is greater than a combined increase in sales quantity of the at least one other item.

18. The system of claim 13, wherein
the first module is configured to generate an intermediate list including at least one second item from the list of candidate items,
the business objective is a price image,
the target is an combined price image as compared to at least one other item in the list of candidate items, and
generating the recommendation list includes selecting the intermediate list as the recommendation list if a combined price image of the at least one second item is less than a combined price image of the at least one other item.

19. The system of claim 13, wherein
the first module is configured to generate an intermediate list including at least one second item from the list of candidate items,
the business objective is a combined revenue,
the target is an increased revenue as compared to at least one other item in the list of candidate items, and
generating the recommendation list includes selecting the intermediate list as the recommendation list if a combined revenue of the at least one second item is greater than a combined revenue of the at least one other item.

20. The system of claim 13, wherein
the first module is configured to generate an intermediate list including at least one second item from the list of candidate items,
the business objective is a combined satisfaction degree,
the target is a combined satisfaction degree as compared to at least one other item in the list of candidate items, and
generating the recommendation list includes selecting the intermediate list as the recommendation list if a combined satisfaction degree of the at least one second item is greater than a combined satisfaction degree of the at least one other item.
